(19) United States
(12) Patent Application Publication
(10) Pub. No.: US 2014/0212700 A1
(43) Pub. Date: Jul. 31, 2014

(54) SECONDARY BATTERY

(71) Applicant: SAMSUNG SDI CO., LTD., Yongin-si (KR)

(72) Inventors: Bo-Hyun Byun, Yongin-si (KR); Jong-Pil Kim, Yongin-si (KR)

(73) Assignee: SAMSUNG SDI CO., LTD., Yongin-si (KR)

(21) Appl. No.: 14/024,587

(22) Filed: Sep. 11, 2013

(30) Foreign Application Priority Data
Jan. 31, 2013 (KR) 10-2013-0011180

(51) Int. Cl. H01M 2/34

(52) U.S. Cl. CPC H01M 2/34
USPC 429/7

(57) ABSTRACT

A secondary battery including a bare cell having an electrode lead; a protective circuit module connected to the electrode lead; a top case at least partially surrounding the protective circuit module; and a bottom case attached to a lower surface of the bare cell is disclosed. In the secondary battery, the bottom case includes first and second films on the lower surface of the bare cell, and the second film has an opening.

### CROSS-REFERENCE TO RELATED APPLICATION

This application claims priority to and the benefit of Korean Patent Application No. 10-2013-0011180, filed on Jan. 31, 2013, in the Korean Intellectual Property Office, the entire content of which is incorporated herein by reference.

### BACKGROUND

1. Field

An aspect of an embodiment of the present invention relates to a secondary battery, and more particularly, to a secondary battery capable of decreasing the thickness thereof while simplifying production processes and reducing production costs.

2. Description of the Related Art

In recent years, as portable information devices such as cellular phones and mobile computers are becoming smaller in size and thinner in thickness, secondary batteries that serve as power sources for the portable information devices are also becoming smaller in size and thinner in thickness.

As different bottom cases were manufactured according to models of secondary batteries, different molds for manufacturing the bottom cases were separately prepared according to the models of secondary batteries, and therefore, process costs were excessively increased. Further, a process of attaching a manufactured bottom case to a bare cell using an adhesive was separately performed, and accordingly, a production process was also added.

### SUMMARY

Aspects of embodiments provide a secondary battery capable of reducing process costs by changing the structure of a bottom case thereof.

Aspects of embodiments also provide a secondary battery capable of simplifying production processes by omitting a process of attaching a bottom case of the secondary battery to a bare cell.

Aspects of embodiments also provide a secondary battery slimmed (e.g., made thinner) by forming a bottom case to be thinner than another bottom case.

According to an embodiment of the present invention, a secondary battery includes: a bare cell having an electrode lead; a protective circuit module connected to the electrode lead; a top case at least partially surrounding the protective circuit module; and a bottom case attached to a lower surface of the bare cell, the bottom case including first and second films on the lower surface of the bare cell, and the second film has an opening.

In some embodiments, a first direction of the bottom case corresponds to a long direction of the lower surface of the bare cell, a second direction of the bottom case corresponds to a short direction of the lower surface of the bare cell perpendicular to the first direction, and the opening may be along the first direction and is parallel to the outer periphery of the bottom case along the first direction.

The opening may include at least two openings that are parallel to each other.

The first film may include a double-faced tape having an adhesive coated thereon.

The adhesive may not be coated on a portion of the first film corresponding to the opening of the second film.

The first film may include a single-faced tape having an adhesive coated on an inside of the first film opposite to the lower surface of the bare cell.

The first film may include a double-faced tape attached to at least one portion of an outside of the first film opposite to the inside of the first film.

A thickness of the second film may be thicker than a thickness of the first film.

A strength of the second film may be stronger than a strength of the first film.

The opening may be formed through engraving.

According to aspects of embodiments of the present invention, the bottom case is configured to have a multi-layered film, so that a process of preparing a mold for separately manufacturing the bottom case can be omitted. Accordingly, it is possible to reduce process costs and to shorten the manufacturing period of the secondary battery according to aspects of embodiments of the present invention.

Further, according to aspects of embodiments of the present invention, an adhesive is provided together with the multi-layered film constituting the bottom case, so that a process of attaching the bottom case of the secondary battery to a bare cell can be omitted, thereby simplifying production processes.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view of a secondary battery according to an embodiment of the present invention.

FIG. 2 is an exploded perspective view of the secondary battery of FIG. 1.

FIG. 3 is a perspective view of a bare cell, viewed from the lower surface thereof, of the secondary battery according to an embodiment of the present invention.

FIG. 4A is a perspective view of a bottom case according to a first embodiment of the present invention.

FIG. 4B is an exploded perspective view of the bottom case according to the first embodiment of the present invention.

FIG. 4C is an exploded perspective view of a bottom case according to a second embodiment of the present invention.

FIG. 5A is a perspective view of the bottom case according to a third embodiment of the present invention.

FIG. 5B is an exploded perspective view of a bottom case according to the third embodiment of the present invention.

FIG. 5C is an exploded perspective view of a bottom case according to a fourth embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, in the context of the present application, when an element is referred to as being “on” another element, it can be directly on the another element or be indirectly on the another element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals refer to like elements. In the drawings, the thickness or size of layers may be exaggerated for clarity and are not necessarily drawn to scale.

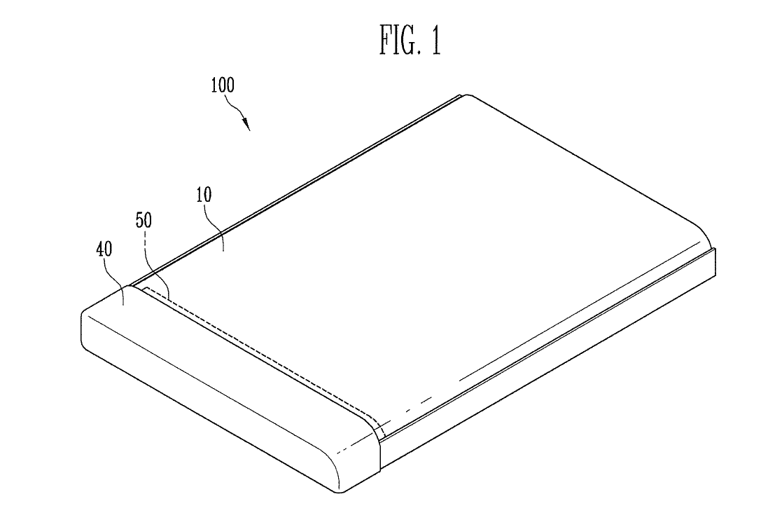

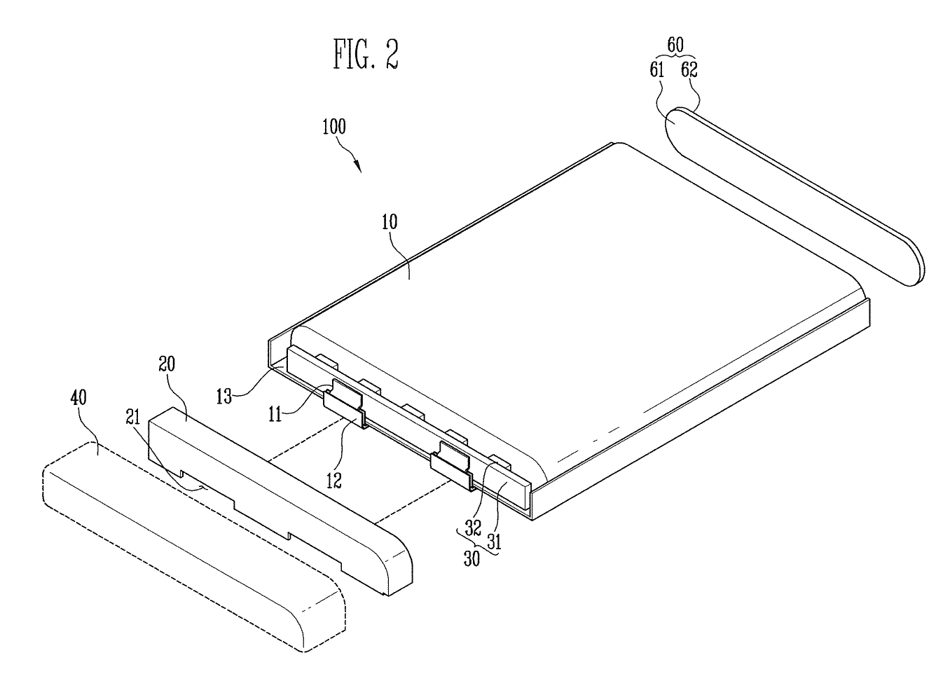

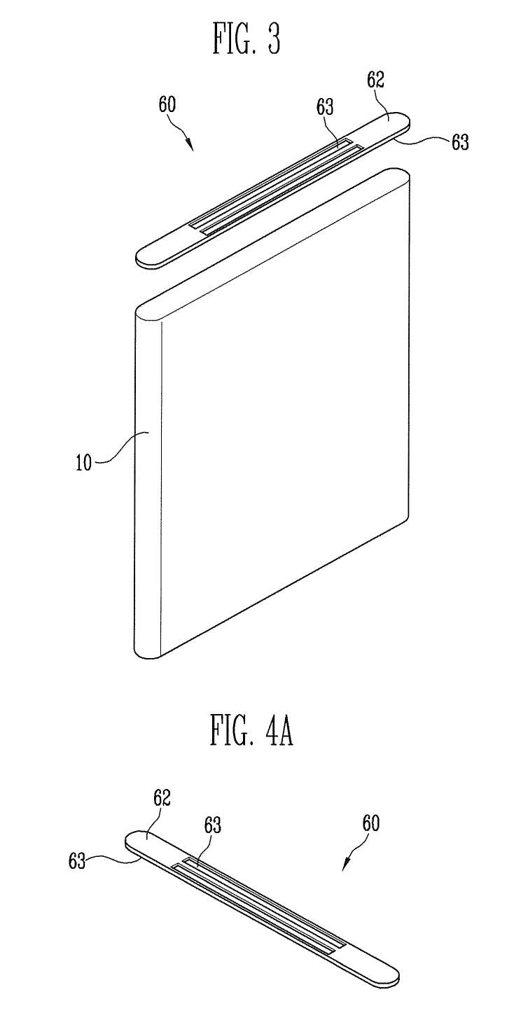

FIG. 1 is a perspective view of a secondary battery according to an embodiment of the present invention. FIG. 2 is an exploded perspective view of the secondary battery of FIG. 1. FIG. 3 is a perspective view of a bare cell, viewed from the lower surface thereof, of the secondary battery according to an embodiment of the present invention.

Referring to FIGS. 1 and 2, the secondary battery 100 according to this embodiment includes a bare cell 10 including electrode leads 11; a protective circuit module 30 connected to (e.g., electrically coupled to) the electrode leads 11; a top case 20 surrounding (e.g., at least partially surrounding) the protective circuit module 30; and a bottom case 60 at (e.g., attached to) a lower surface of the bare cell 10. The bottom case 60 includes a first film 61 (e.g., a first film member 61) and a second film 62 (e.g., a second film member 62) from the lower surface of the bare cell 10, and an opening 63 (see FIG. 3) is at (e.g., formed in) the second film 62.

The bare cell 10 accommodates an electrode assembly therein, and may have a terrace portion 13. The terrace portion may be a sealing region positioned in the extraction direction of the electrode leads 11 that are respectively connected to electrode tabs of the electrode assembly. The protective circuit module 30 connected to the electrode leads 11 is positioned at the terrace portion 13. In this embodiment, the top case 20 may have a cross-section having a ‘ [symbol] ’ shape to surround (or partially surround) the protective circuit module 30. The top case 20 may surround (or partially surround) a mounting surface of components 32 of the protective circuit module 30, a connection surface between the protective circuit module 30 and the electrode leads 11, and a surface of the protective circuit module 30 that is opposite to a surface of the protective circuit module 30 that faces the terrace portion 13.

An insulator 40 includes an insulative tape, and may cover the top case 20 while facing the top case 20. The insulator 40 may be further extended to partially cover a region (e.g., a partial region) of the bare cell 10. The insulator 40 configured as described above is formed in a single body to cover the top case 20 or partially cover the region of the bare cell 10 without any gap (or with a reduced amount of gap). Thus, the insulator 40 can prevent the components 32 from being damaged (or reduce an amount of damage to the components 32) when an impact occurs between the components 32 and the top case 20 due to inflow of external foreign matter.

An exterior tape 50 connects the bare cell 10 and the protective circuit module 30 to each other, and covers or partially covers (e.g., is formed to cover or partially cover) the outside of the top case 20 in a state in which the top case 20 surrounds (or partially surrounds) the protective circuit module 30. For example, the exterior tape 50 covers an upper portion of the bare cell 10, so that the top case 20 can be easily fixed to the terrace portion 13 of the bare cell 10.

Hereinafter, components of the secondary battery 100 according to embodiments of the present invention will be described.

First, the electrode assembly is accommodated inside a pouch of the bare cell 10, and the bare cell 10 has the terrace portion 13 that is a sealing region positioned in the extraction direction of the electrode leads 11 that are respectively connected to the electrode tabs of the electrode assembly. The sealing region may be positioned at both sides of the terrace portion 13, to which the electrode leads 11 are extracted, and the sealing region may be adhered closely to the pouch of the bare cell 10 while being folded to a side portion of the pouch.

The pouch may be prepared by performing an insulation process on the surface of a metallic thin plate, such as an aluminum thin plate. For example, for the pouch of the bare cell 10, cast polypropylene (CPP), a polymer resin, is coated on an aluminum thin plate to form a thermal adhesive layer, and a resin material, such as nylon or polyethylene terephthalate (PET), is formed on an outer surface of the thermal adhesive layer.

The electrode assembly accommodated inside the pouch has a structure in which a positive electrode plate, a negative electrode plate, and a separator interposed therebetween are sequentially stacked or wound. The electrode tabs attached to the positive and negative electrode plates are electrically connected to the respective electrode leads 11 having different polarities. Portions of the electrode leads 11 are exposed at (or to) the terrace portion 13 of the pouch so as to allow electrical connection of the electrode leads 11 to the protective circuit module 30 in a subsequent process.

In this embodiment, an insulation tape 12 is further provided at an outer surface of each electrode lead 11 positioned at the terrace portion 13. The insulation tape 12 may (e.g., be formed to) improve the sealing between the electrode lead 11 and the pouch of the bare cell 10 and to secure an electrical insulation state.

The protective circuit module 30 is positioned at the terrace portion 13 of the bare cell 10, and positive and negative electrode terminals electrically connected to the respective electrode leads 11 are provided at a surface of the protective circuit module 30. Another surface of the protective circuit module 30 (e.g., a surface opposite to the surface at which the electrode leads 11 are located) has a structure in which various suitable electronic components 32 are mounted on a printed circuit board 31 having a printed circuit portion printed thereon. A flexible circuit board extended from the printed circuit board 31 may be further provided at an end portion of the printed circuit board 31. The flexible circuit board is formed to extend to at least one surface of the bare cell 10, and may have a connector for external terminal connection provided to at least a portion of the flexible circuit board. A connector component may be mounted to the connector so as to be connected to an external power source.

Here, the insulator 40 may accommodate and cover the flexible circuit board. The insulator 40 is formed as a single body to cover the top case 20 or the region (e.g., the partial region) of the bare cell 10 without any gap (or with a reduced amount of gap). Thus, the insulator 40 can prevent the components 32 from being damaged (or reduce an amount of damage to the components 32) when an impact occurs between the components 32 and the top case 20 due to inflow of external foreign matters. The insulator 40 covers the upper portion of the bare cell 10, so that the top case 20 can be easily fixed to the terrace portion 13 of the bare cell 10.

The top case 20 is formed to surround (or partially surround) the protective circuit module 30, thereby protecting the protective circuit module 30. The top case 20 is mounted on the upper surface of the bare cell 10, e.g., the terrace portion 13 of the bare cell 10. In the top case 20, grooves 21 are respectively formed at (e.g., in) regions corresponding to electrode leads 11, so as to avoid interference of the top case 20 with the electrode leads 11. In this embodiment, the insulation tape 12 extends up to the outer surface of the electrode lead 11 exposed through the groove 21 of the top case 20, thereby preventing (or reducing the likelihood of) a short circuit. An adhesive layer may be further provided between the upper surface of the bare cell 10 and the top case 20 so as to improve the coupling between the bare cell 10 and the top case 20.

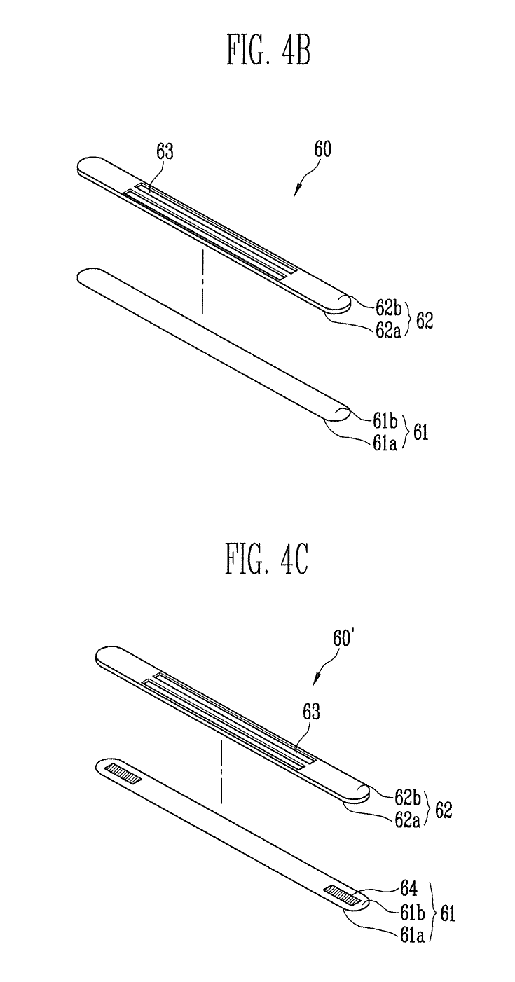

Referring to FIG. 3, the bottom case 60 according to this embodiment includes the first and second films 61 and 62 from the lower surface of the bare cell 10, and the opening 63 is at (e.g., formed in) the second film 62. The structure of the bottom case 60 according to this embodiment will be described in more detail with reference to FIGS. 4A to 4C.

FIG. 4A is a perspective view of a bottom case according to a first embodiment of the present invention. FIG. 4B is an exploded perspective view of the bottom case according to the first embodiment of the present invention. FIG. 4C is an exploded perspective view of a bottom case according to a second embodiment of the present invention.

Referring to FIG. 4A, a first direction of the bottom case 60 according to the first embodiment corresponds to a long direction of the bare cell 10 (e.g., see the length of the lower surface of the battery cell of FIG. 2) and a second direction of the bottom case 60 corresponds to a short direction of the bare cell 10, perpendicular to the first direction (e.g., see the width of the lower surface of the battery cell of FIG. 2). Openings 63 are formed along the first direction in parallel with the outer periphery (e.g., the outer circumference) along the first direction of the bottom case 60. The number of the openings 63 is two, and the two openings 63 are parallel to each other.

Referring to FIG. 4B, a first film 61 includes a double-faced tape having an adhesive coated on an inside 61a of the first film 61, opposite to the lower surface of the bare cell 10. Adhesive is also coated on an outside 61b of the first film 61, which is a surface opposite to the inside 61a of the first film 61. Accordingly, the inside 61a of the first film 61 can be attached to the lower surface of the bare cell 10, and simultaneously (or concurrently), the outside 61b of the first film 61 can be attached to an inside 62a of a second film 62. Here, an outside 62b of the second film 62 is a surface opposite to the inside 62a of the second film 62.

However, the adhesive is not coated on a portion of the first film 61 corresponding to the opening 63 formed in the second film 62 when the outside 61b of the first film 61 is attached to the inside 62a of the second film 62. For example, if the adhesive is also coated on the outside 61b of the first film 61, corresponding to the opening 63, dust or foreign matter may be attached later to the outside 61b of the first film 61 through the opening 63. Accordingly, the outside 61b of the first film 61 may have a portion corresponding to the opening 63 of the second film 62 that is free or substantially free of adhesive. Meanwhile, the opening 63 is formed through, for example, engraving.

Referring to FIG. 4C, a first direction of a bottom case 60′ according to a second embodiment corresponds to a long direction of the bare cell 10 (e.g., see the length of the lower surface of the battery cell of FIG. 2) and a second direction of the bottom case 60′ corresponds to a short direction of the bare cell 10 (e.g., see the width of the lower surface of the battery cell of FIG. 2), perpendicular to the first direction. Openings 63 are formed along the first direction in parallel with the outer periphery (e.g., the outer circumference) along the first direction of the bottom case 60′. The number of the openings 63 is two, and the two openings 63 are parallel to each other. Meanwhile, the opening 63 is formed through, for example, engraving.

The first film 61 includes a single-faced tape having an adhesive coated on the inside 61a of the first film 61, opposite to the lower surface of the bare cell 10. A tape 64 (e.g., a double-faced tape member) having adhesive coated thereon is provided to at least one portion of the outside 61b of the first film 61, which is a surface opposite to the inside 61a of the first film 61. Accordingly, the inside 61a of the first film 61 can be attached to the lower surface of the bare cell 10, and simultaneously (or concurrently), the outside 61b of the first film 61 can be attached to the inside 62a of the second film 62. Here, the outside 62b of the second film 62 is a surface opposite to the inside 62a of the second film 62.

Although it has been described in the first and second embodiments that the number of the openings 63 is two, the present invention is not limited thereto. For example, the number of the openings 63 may be one, as will be described in third and fourth embodiments. It is, or will be, apparent that the number of the openings 63 may be formed to be three or more when necessary.

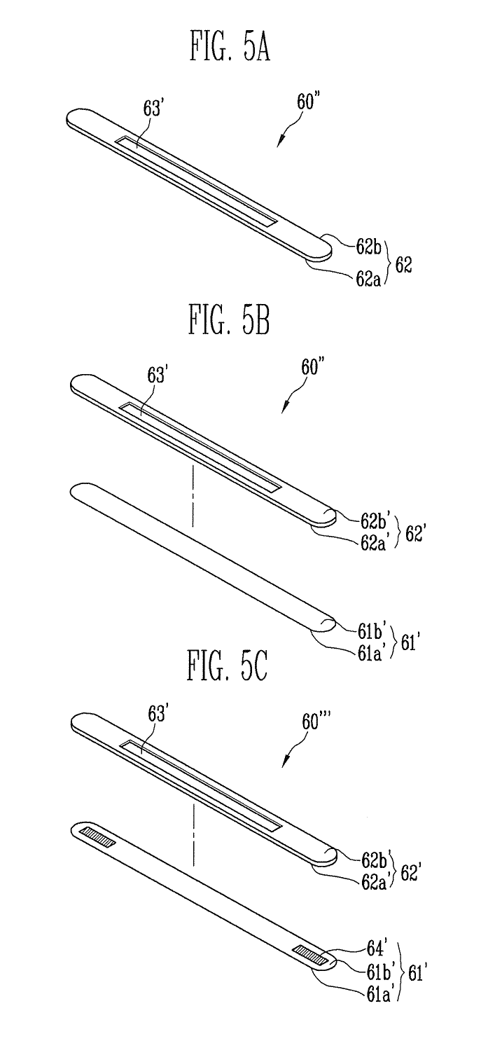

FIG. 5A is a perspective view of the bottom case according to a third embodiment of the present invention. FIG. 5B is an exploded perspective view of a bottom case according to the third embodiment of the present invention. FIG. 5C is an exploded perspective view of a bottom case according to a fourth embodiment of the present invention.

Referring to FIG. 5A, a first direction of the bottom case 60″ according to the third embodiment corresponds to a long direction of the bare cell 10 (e.g., see the length of the lower surface of the battery cell of FIG. 2) and a second direction of the bottom case 60″ corresponds to a short direction of the bare cell 10 (e.g., see the width of the lower surface of the battery cell of FIG. 2), perpendicular to the first direction. An opening 63′ is formed along the first direction in parallel with the outer periphery (e.g., the outer circumference) along the first direction of the bottom case 60′. Here, only one opening 63 is formed.

Referring to FIG. 5B, a first film 61′ includes a double-face tape having an adhesive coated on an inside 61a′ of a first film 61′, opposite to the lower surface of the bare cell. Adhesive is also coated on an outside 61b′ of the first film 61′, which is a surface opposite to the inside 61a′ of the first film 61′. Accordingly, the inside 61a′ of the first film 61′ can be attached to the lower surface of the bare cell 10, and simultaneously (or concurrently), the outside 61b′ of the first film 61′ can be attached to an inside 62a′ of a second film 62′. Here, an outside 62b′ of the second film 62′ is a surface opposite to the inside 62a′ of the second film 62′.

However, the adhesive is not coated on a portion corresponding to the opening 63′ formed in the second film 62′ when the outside 61b′ of the first film 61′ is attached to the inside 62a′ of the second film 62′. For example, if the adhesive is also coated on the outside 61b′ of the first film 61′, corresponding to the opening 63′, dust or foreign matter may be attached later to the outside 61b′ of the first film 61′ through the opening 63′. Accordingly, the outside 61b′ of the first film 61 may have a portion corresponding to the opening 63′ of the second film 62′ that is free or substantially free of adhesive. Meanwhile, the opening 63 is formed through, for example, engraving.

Referring to FIG. 5C, a first direction of the bottom case 60′″ according to a fourth embodiment corresponds to a long direction of the bare cell 10 (e.g., see the length of the lower surface of the battery cell of FIG. 2) and a second direction of the bottom case 60′″ corresponds to a short direction of the bare cell 10 (e.g., see the width of the lower surface of the battery cell of FIG. 2), perpendicular to the first direction. An opening 63′ is formed along the first direction in parallel with the outer periphery (e.g., the outer circumference) along the first direction of the bottom case 60′″. Only one opening 63′ is formed. Meanwhile, the opening 63′ is formed through, for example, engraving.

The first film 61′ includes a single-faced tape having an adhesive coated on the inside 61a′ of the first film 61′, opposite to the lower surface of the bare cell 10. A tape 64′ (e.g., a double-faced tape member) having adhesive coated thereon is provided to at least one portion of the outside 61b′ of the first film 61′, which is a surface opposite to the inside 61a′ of the first film 61′. Accordingly, the inside 61a′ of the first film 61′ can be attached to the lower surface of the bare cell 10, and accordingly, the outside 61b′ of the first film 61′ can be attached to the inside 62a′ of the second film 62′. Here, the outside 62b′ of the second film 62′ is a surface opposite to the inside 62a′ of the second film 62′.

In all of the above-described embodiments, the openings 63 and 63′ are formed through engraving. The opening is used to easily extract a pack of the secondary battery after the pack of the secondary battery is completed. The opening has a structure capable of substituting for a conventional fingernail holding structure which is formed through embossing and extracted from the pack of the secondary battery. Thus, the bottom case can be formed to be thinner than the conventional bottom case, thereby implementing miniaturization (or size reduction) and thinning of the secondary battery.

In all of the above-described embodiments, the thickness of the second film 62 positioned further outward from the bare cell 10 than the first film 61 is formed thicker than that of the first film 61, in terms of improving the rigidity of the secondary battery 100. Meanwhile, in addition to the method of adjusting the thickness of the film, the material of the film may be changed so that the strength of the second film 62 positioned further outward from the bare cell 10 than the first film 61 is stronger than that of the first film 61.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A secondary battery, comprising:
a bare cell having an electrode lead;
a protective circuit module connected to the electrode lead;
a top case at least partially surrounding the protective circuit module; and
a bottom case attached to a lower surface of the bare cell, the bottom case comprising first and second films on the lower surface of the bare cell, and the second film having an opening.

2. The secondary battery of claim 1, wherein a first direction of the bottom case corresponds to a long direction of the lower surface of the bare cell, a second direction of the bottom case corresponds to a short direction of the lower surface of the bare cell perpendicular to the first direction, and the opening is along the first direction and is parallel to the outer periphery of the bottom case along the first direction.

3. The secondary battery of claim 2, wherein the opening includes at least two openings that are parallel to each other.

4. The secondary battery of claim 1, wherein the first film comprises a double-faced tape having an adhesive coated thereon.

5. The secondary battery of claim 4, wherein the adhesive is not coated on a portion of the first film corresponding to the opening of the second film.

6. The secondary battery of claim 1, wherein the first film comprises a single-faced tape having an adhesive coated on an inside of the first film opposite to the lower surface of the bare cell.

7. The secondary battery of claim 6, wherein the first film has a double-faced tape attached to at least one portion of an outside of the first film opposite to the inside of the first film.

8. The secondary battery of claim 1, wherein a thickness of the second film is thicker than a thickness of the first film.

9. The secondary battery of claim 1, wherein a strength of the second film is stronger than a strength of the first film.

10. The secondary battery of claim 1, wherein the opening is formed through engraving.
